(19) United States
(12) Patent Application Publication
(10) Pub. No.: US 2012/0123645 A1
(43) Pub. Date: May 17, 2012

(54) PASSENGER-SHIFT AIRBAG APPARATUS, SIDE AIRBAG SYSTEM HAVING THE SAME, AND METHOD OF CONTROLLING SIDE AIRBAG SYSTEM

(75) Inventors: Hyock In Kwon, Seongnam-si (KR); Hyeong Ho Choi, Gwangmyeong-si (KR); Seung Woo Lee, Suwon-si (KR); Jae Ho Choi, Seoul (KR)

(73) Assignee: Hyundai Motor Company, Seoul (KR)

(21) Appl. No.: 13/165,255

(22) Filed: Jun. 21, 2011

(30) Foreign Application Priority Data
Nov. 11, 2010 (KR) 10-2010-0112113

(51) Int. Cl. B60R 21/0134; B60R 21/0136; B60R 21/16

(52) U.S. Cl. 701/46; 280/728.2; 280/730.2

(57) ABSTRACT

A passenger-shift airbag apparatus may include an inflator installed at a predetermined position in a seat back of a vehicle; and a passenger-shift airbag cushion fluid-connected to the inflator directly or by a gas supply tube, the passenger-shift airbag cushion being located in the seat back adjacent to a lateral side of the seatback, so that when the passenger-shift airbag cushion is inflated by gas supplied from the inflator, the passenger-shift airbag cushion shifts the passenger towards an inside of the vehicle.

### CROSS-REFERENCE TO RELATED APPLICATIONS

The present application claims priority to Korean Patent Application No. 10-2010-01112113 filed on Nov. 11, 2010, the entire contents of which is incorporated herein for purposes by this reference.

### BACKGROUND OF THE INVENTION

1. Field of the Invention

The present invention relates to a passenger shift airbag apparatus which shifts a passenger in an opposing direction to a side at which a side collision of a vehicle occurs in order to secure space required to protect the passenger when the side collision occurs, thus enhancing the performance of protecting the passenger, and a side airbag system having the passenger shift airbag apparatus, and a method of controlling the side airbag system.

2. Description of Related Art

Generally, various kinds of safety devices are provided in vehicles to protect drivers and passengers when the vehicles are involved in collisions. Safety belts and airbag apparatuses are representative examples of such safety devices.

The airbag apparatuses momentarily inject compressed gas into an airbag cushion to rapidly inflate the airbag cushion when a vehicle collision occurs, thus preventing a passenger from colliding with a part, such as a windshield or a steering wheel of a vehicle.

Recently, side airbag apparatuses have been developed to protect passengers from impacts generated not only in frontal but also side collisions. Such side airbag apparatuses are installed at predetermined positions in seat backs and protect the chests and the pelvic regions of passengers from impact.

However, depending on the conditions of a vehicle collision, even when the vehicles are provided with the side airbag apparatuses, the passengers may collide first with parts of the vehicles before the side airbag apparatuses are operated. In this case, the passengers cannot be protected from the side collisions.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to provide a passenger-shift airbag apparatus which shifts a passenger in a direction opposite to a side at which a side collision of a vehicle occurs to secure space required to protect the passenger when the side collision occurs, thus enhancing the performance of protecting the passenger, to provide a side airbag system which includes not only a side airbag apparatus but also the passenger-shift airbag apparatus so that the passenger can be more reliably protected from an impact, and to provide a method of controlling the side airbag system which predicts a side collision and previously deploys the passenger-shift airbag before the side collision takes place, and moves up the point of time at which the side airbag deploys, when the side collision is predicted to be about to happen, thus further enhancing the performance of protecting the passenger when the side collision occurs.

In aspect of the present invention, the passenger-shift airbag apparatus, may include an inflator installed at a predetermined position in a seat back of a vehicle, and a passenger-shift airbag cushion fluid-connected to the inflator directly or by a gas supply tube, the passenger-shift airbag cushion being located in the seat back adjacent to a lateral side of the seatback, so that when the passenger-shift airbag cushion may be inflated by gas supplied from the inflator, the passenger-shift airbag cushion shifts the passenger towards an inside of the vehicle.

The passenger-shift airbag apparatus may further include a tether provided in the passenger-shift airbag cushion to connect the seatback and an inner surface of the passenger-shift airbag cushion.

The tether may have at least a gas guide hole to control a flow of the gas such that when the passenger-shift airbag cushion may be inflated, the passenger-shift airbag cushion first pushes the outside shoulder and the abdomen of the passenger inwards.

In another aspect of the present invention, the side airbag system having the passenger-shift airbag apparatus, may include a side airbag apparatus provided in the seatback at a predetermined position spaced apart from the passenger-shift airbag apparatus in a predetermined distance, a vehicle-operation-condition sensing module having sensors sensing operational conditions of the vehicle that may include whether a brake of the vehicle may be normal, a speed, a yaw rate and a position of the vehicle, a pre-crash sensor sensing another vehicle approaching a sidewall of the vehicle, a side impact sensor sensing a side collision of the vehicle, and a control unit controlling deployment of the passenger-shift airbag apparatus and the side airbag apparatus and points of time of the deployment of the passenger-shift airbag apparatus and the side airbag apparatus, depending on information collected from the vehicle-operation-condition sensing module, the pre-crash sensor and the side impact sensor.

In further another aspect of the present invention, a method of controlling the side airbag system may include steps of receiving pre-crash sensing information from the vehicle-operation-condition sensing module and the pre-crash sensor, determining whether the another vehicle predicted to cause the side collision may be approaching the vehicle at a predetermined speed or more from a predetermined direction using the pre-crash sensing information, determining whether there may be a 100% probability that the another vehicle predicted to cause the side collision collides with the vehicle at a speed higher than a reference speed, and deploying the passenger-shift airbag apparatus at a point of time earlier than a point of time of the collision when it may be determined that the probability of the side collision may be 100%.

The method may further include, between the determining of whether the another vehicle predicted to cause the side collision may be approaching the vehicle and the determining whether the probability may be 100%, moving up a reference time point at which the side airbag apparatus deploys, when it may be determined that the another vehicle predicted to cause the collision may be approaching the vehicle at the predetermined speed or more from the predetermined direction, after the deploying of the passenger-shift airbag apparatus, determining whether the side collision has occurred using information transmitted from the side impact sensor, and deploying the side airbag apparatus at a predetermined point of time when it may be determined that the side collision has occurred.

The method may include, in the determining of whether the side collision predicted vehicle approaches the vehicle, when it may be determined that the another vehicle predicted to cause the side collision may be not approaching the vehicle at the predetermined speed or more from the predetermined direction, determining whether the side collision has occurred using information transmitted from the side impact sensor, and when it may be determined that the side collision has occurred, deploying the side airbag apparatus at a predetermined point of time or deploying the passenger-shift airbag apparatus and the side airbag apparatus at a same time at a predetermined point of time.

The method may further include, in the determining of whether the probability may be 100%, when it may be determined that the probability may be not 100%, determining whether the side collision has occurred using information transmitted from the side impact sensor, when it may be determined that the side collision has occurred, deploying the passenger-shift airbag apparatus at a predetermined point of time, and when it may be determined that the side collision has occurred, deploying the side airbag apparatus at the predetermined point of time.

The method may further include in the determining of whether the side collision has occurred, when it may be determined that the side collision has not occurred, resetting a reference time point at which the side airbag apparatus deploys to an origin.

The method may further include, in the determining of whether the side collision has occurred, when it may be determined that the side collision has not occurred, resetting the reference time point at which the side airbag apparatus deploys to an origin.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view showing a passenger-shift airbag apparatus and a side airbag apparatus, according to an exemplary embodiment of the present invention.

FIG. 2 is a sectional view taken along line A-A of FIG. 1.

FIG. 3 is a sectional view showing deployment of the passenger-shift airbag apparatus and the side airbag apparatus according to an exemplary embodiment of the present invention.

FIG. 4 is a sectional view taken along line B-B of FIG. 3.

FIG. 5 is a view corresponding to FIG. 4, but showing a modification of the exemplary embodiment of FIG. 3.

FIG. 6 is a block diagram showing a side airbag system according to an exemplary embodiment of the present invention.

FIG. 7 is a flowchart of a method of controlling the side airbag system of FIG. 6.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In the following description, when it was determined that a detailed description of the conventional function and conventional structure would confuse the gist of the present invention, such description may have been omitted. Reference now should be made to the drawings, in which the same reference numerals are used throughout the different drawings to designate the same or similar components.

Hereinafter, preferred embodiments of the present invention will be described in detail with reference to the attached drawings.

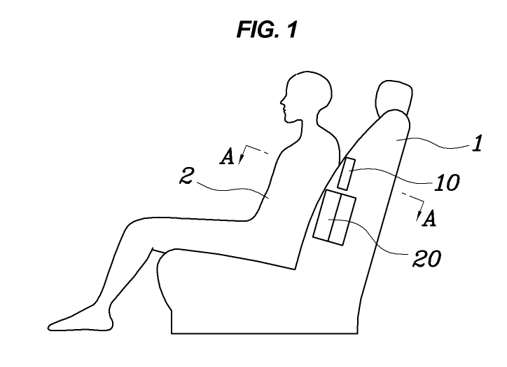

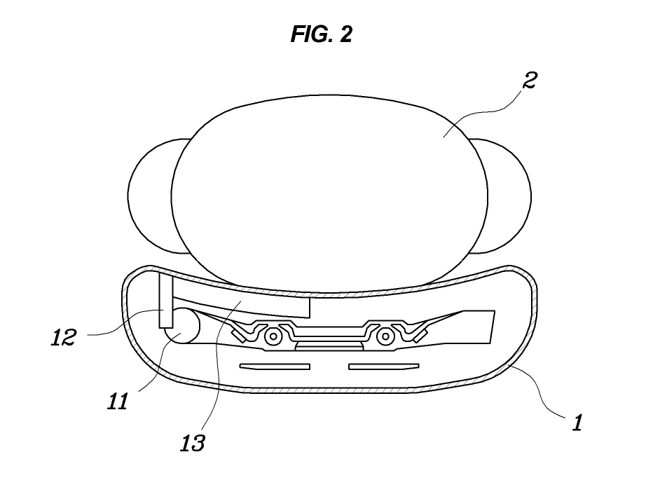

As shown in FIGS. 1 through 3, a passenger-shift airbag apparatus according to an exemplary embodiment of the present invention includes an inflator 11 and a passenger-shift airbag cushion 13. The inflator 11 is installed at a predetermined position in a seat back 1 of a vehicle. The passenger-shift airbag cushion 13 may be directly connected to the inflator 11 or, alternatively, the cushion 13 may be connected to the inflator 11 by a gas supply tube 12.

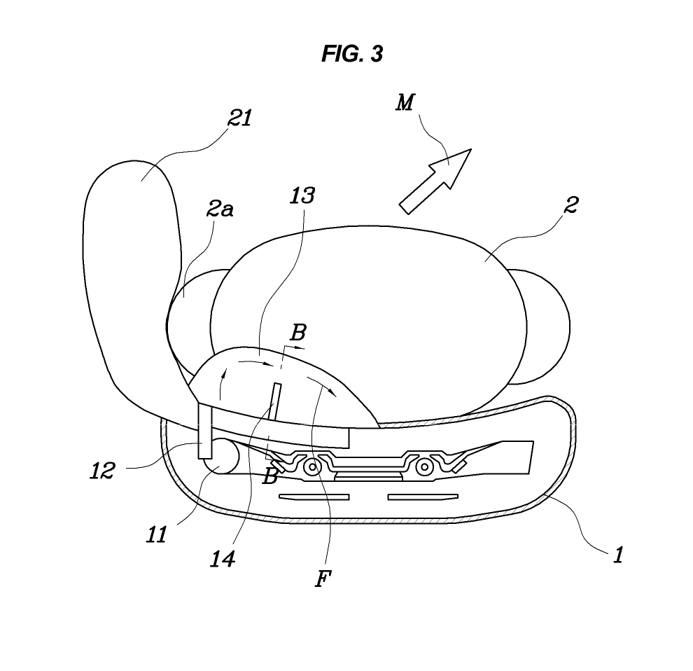

The passenger-shift airbag cushion 13 is located in the seat back 1 at a position adjacent to an outside shoulder 2a of a passenger 2 so that when the passenger-shift airbag cushion 13 is inflated by gas supplied from the inflator 11, the cushion 13 shifts the passenger 2 towards the inside of the vehicle, in other words, in a direction designated by the arrow M of FIG. 3.

Furthermore, a tether 14 is provided in the passenger-shift airbag cushion 13.

The tether 14 may have a gas guide hole 14b, 14c which controls the flow of gas along the direction designated by the arrow F of FIG. 3 such that when the passenger-shift airbag cushion 13 is inflated, the cushion 13 first pushes the outside shoulder 2a of the passenger inwards.

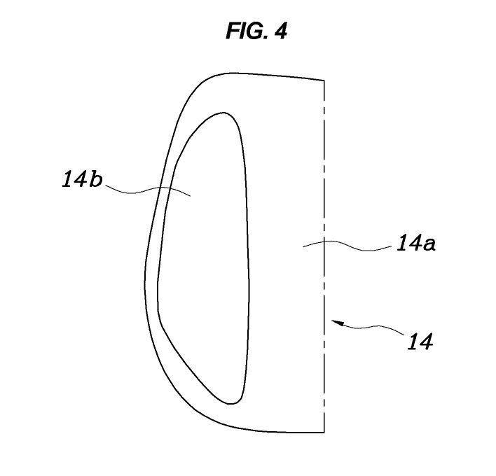

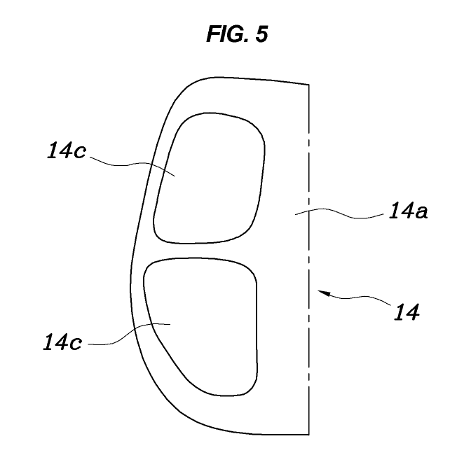

As shown in FIG. 4, the tether 14 may include a diaphragm 14a which blocks the flow of gas, and a single gas guide hole 14b which is formed through a portion of the diaphragm 14a at a position adjacent to one edge of the diaphragm 14a. Alternatively, as shown in FIG. 5, the tether 14 may include a diaphragm 14a which blocks the flow of gas, and a pair of gas guide holes 14c which are formed through a portion of the diaphragm 14a at a position adjacent to one edge of the diaphragm 14a.

The passenger-shift airbag cushion 13 should not interfere with the operation of a side airbag cushion 21. For this, as shown in FIG. 1, it is desirable that a passenger-shift airbag apparatus 10 be located at a position spaced apart from a side airbag apparatus 20 by a predetermined distance.

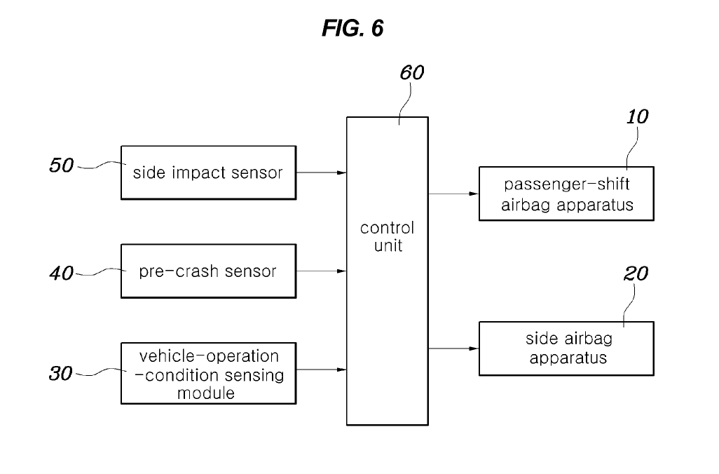

Meanwhile, referring to FIG. 6, a side airbag system according to an exemplary embodiment of the present invention includes a passenger-shift airbag apparatus 10, a side airbag apparatus 20, a vehicle-operation-condition sensing module 30, a pre-crash sensor 40, a side impact sensor 50 and a control unit 60. The passenger-shift airbag apparatus 10 includes an inflator 11, a gas supply tube 12 and a passenger-shift airbag cushion 13. The inflator 11 is installed at a predetermined position in a seat back 1 of a vehicle. The gas supply tube 12 is connected to the inflator 11. The passenger-shift airbag cushion 13 is connected to the gas supply tube 12 and located in the seat back 1 at a position adjacent to the outside shoulder 2a of the passenger 2 so that when the passenger-shift airbag cushion 13 is inflated by gas supplied from the inflator 11, the cushion 13 shifts the passenger 2 towards the inside of the vehicle, in other words, in the direction designated by the arrow M. The side airbag apparatus 20 is provided in the seat back 1 at a predetermined position spaced apart from the passenger-shift airbag apparatus 10 by a predetermined distance. The vehicle-operation-condition sensing module 30 includes various sensors which sense the operational conditions of the vehicle, for example, whether a brake system of the vehicle is normal, the speed, the yaw rate, the position of the vehicle, etc. The pre-crash sensor 40 senses another vehicle which approaches the sidewall of the vehicle. The side impact sensor 50 senses a side collision of the vehicle. The control unit 60 controls deployment of the passenger-shift airbag apparatus 10 and the side airbag apparatus 20 and controls the point of time at which the apparatuses 10 and 20 are deployed, using information collected from the vehicle-operation-condition sensing module 30, the pre-crash sensor 40 and the side impact sensor 50.

In the exemplary embodiment, a tether 14 may be provided in the passenger-shift airbag cushion 13. This tether 14 has a gas guide hole 14b, 14c which controls the flow of gas such that when the passenger-shift airbag cushion 13 is inflated, the cushion 13 pushes the outside shoulder 2a of the passenger inwards. It is desirable that a radar sensor which can perform the sensing operation every 5 ms be used as the pre-crash sensor 40. It is desirable that a radar sensor which can perform the sensing operation every 40 ms to 50 ms be used as the side impact sensor 50.

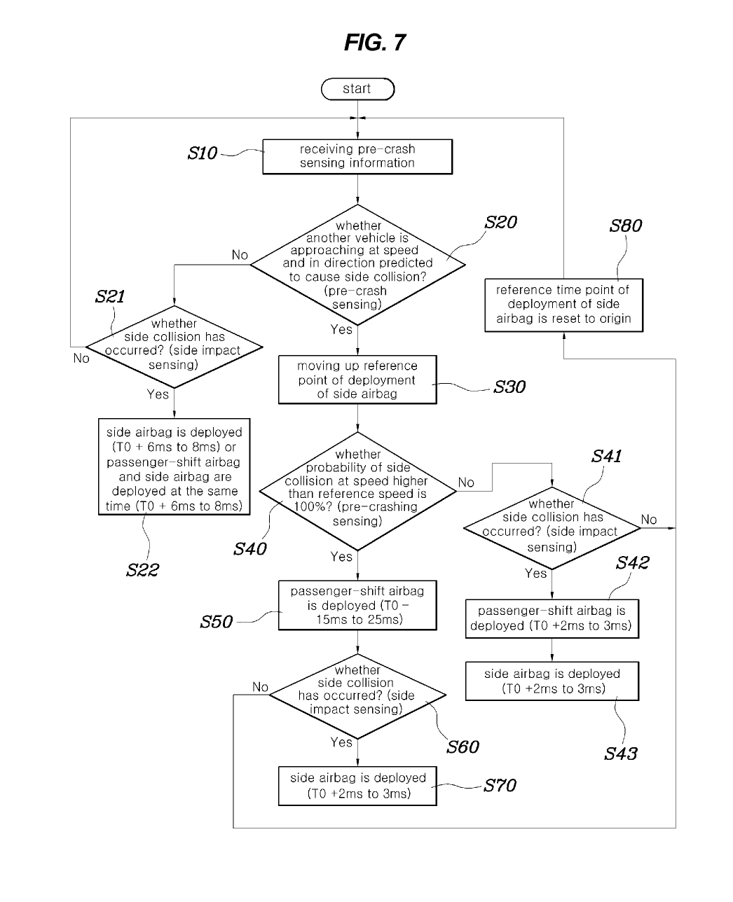

Below a method of controlling the side airbag system including the passenger-shift airbag apparatus 10, the side airbag apparatus 20, the vehicle-operation-condition sensing module 30, the pre-crash sensor 40, the side impact sensor 50 and the control unit 60 will be described with reference to FIG. 7.

The method includes step S10 of receiving pre-crash sensing information from the vehicle-operation-condition sensing module 30 and the pre-crash sensor 40. At step S20, whether a vehicle predicted to cause a side collision is approaching the vehicle at a predetermined speed or more from a predetermined direction is determined using the pre-crash sensing information. At step S40, whether a probability that the side collision predicted vehicle collides with the vehicle at a speed higher than a reference speed is 100% or not is determined. At step S50, when it is determined that the probability of the side collision is 100%, the passenger-shift airbag apparatus is deployed at a point of time (a collision time point T0−15 ms to 25 ms) earlier than the collision time point T0.

“Pre-crash sensing information” refers to all information transmitted from not only the pre-crash sensor 40 but also the vehicle-operation-condition sensing module 30.

In the method of controlling the side airbag system according to an exemplary embodiment of the present invention, the passenger-shift airbag apparatus can be deployed at a point of time (the collision time point T0−15 ms to 25 ms) earlier than the collision time point T0. Therefore, the passenger-shift airbag apparatus can shift the passenger towards the side opposite to the side at which the collision occurs even before the vehicle is involved in the collision so that a space that is required for protecting the passenger is created beforehand. Thereby, the performance of protecting the passenger can be enhanced.

Furthermore, between step S20 and step S40, the method of controlling the side airbag system further includes step S30 of moving up a reference time point at which the side airbag apparatus 20 deploys, when it is determined that the collision predicted vehicle approaches the vehicle at a predetermined speed or more in a predetermined direction. After step S50 is conducted, whether a side collision has occurred is determined using side collision information transmitted from the side impact sensor 50, at step S60. At step S70, when it is determined that the side collision has occurred, the side airbag apparatus is deployed at a predetermined point of time (the collision time point T0+2 ms to 3 ms).

As such, the present invention previously sets step S30 of moving up the reference time point at which the side airbag apparatus 20 deploys when it is determined that the side collision predicted vehicle approaches the vehicle at the predetermined speed or more in the predetermined direction. Therefore, when the side collision substantially occurs, the side airbag apparatus 20 can be deployed at a point of time (the collision time point T0+2 ms to 3 ms) earlier than the conventional deployment time point (the collision time point T0+6 ms to 8 ms). Thereby, the performance of protecting the passenger using the side airbag apparatus 20 can be further enhanced.

Meanwhile, if, at step S20, it is determined that the side collision predicted vehicle does not approach the vehicle at the predetermined speed or more in the predetermined direction, at step S21, whether a side collision has occurred is determined using information transmitted from the side impact sensor 50. At step S22, when it is determined that the side collision has occurred, the side airbag apparatus is deployed at a predetermined point of time (the collision time point T0+6 ms to 8 ms) or the passenger-shift airbag apparatus and the side airbag apparatus are deployed at the same time at a predetermined point of time equal to the collision time point T0+6 ms to 8 ms.

Steps S21 and S22 pertain to the operation of controlling the point in time at which the passenger-shift airbag apparatus 10 and the side airbag apparatus 20 are deployed when the side collision has not been predicted but the side collision actually occurs. In other words, when, at step S20, it is determined that the side collision predicted vehicle is not approaching the vehicle at a speed equal to or greater than the predetermined speed in the predetermined direction but the side collision actually occurs, the side airbag apparatus 20 is deployed at the predetermined point of time (the collision time point T0+6 ms to 8 ms) in the same manner as that of the conventional technique. The passenger-shift airbag apparatus 10 is also deployed at the predetermined point of time (the collision time point T0+6 ms to 8 ms).

Meanwhile, when, at step S40, it is determined that the probability of a side collision is not 100%, whether the side collision has occurred is determined using information transmitted from the side impact sensor 50, at step S41. At step S42, when it is determined that the side collision has occurred, the passenger-shift airbag apparatus is deployed at a predetermined point of time (the collision time point T0+2 ms to 3 ms). At step S43, when it is determined that the side collision has occurred, the side airbag apparatus is deployed at the predetermined point of time (the collision time point T0+2 ms to 3 ms).

Steps S41, S42 and S43 pertain to the operation of controlling the point of time at which the passenger-shift airbag apparatus 10 and the side airbag apparatus 20 are deployed when a side collision is predicted but the probability of the side collision is comparatively low. Therefore, when it is determined that the vehicle expected to cause the side collision is not approaching the vehicle at a speed equal to or greater than the predetermined speed from in the predetermined direction, at step S40, but the side collision actually occurs, the side airbag apparatus 20 is deployed at a point of time (the collision time point T0+2 ms to 3 ms) earlier than the conventional deployment time point (the collision time point T0+6 ms to 8 ms), and the passenger-shift airbag apparatus 10 is deployed at the point of time (the collision time point T0+2 ms to 3 ms).

Meanwhile, when, at step S41, it is determined that the side collision has not occurred, the reference time point at which the side airbag apparatus 20 deploys is reset to the origin, at step S80. Furthermore, when, at step S60, it is determined that the side collision has not occurred, the reference time point at which the side airbag apparatus 20 deploys is also reset to the origin, at step S80.

As described above, in a passenger-shift airbag apparatus according to an exemplary embodiment of the present invention, when a side collision occurs, a passenger-shift airbag cushion shifts a passenger in a direction opposite to a side at which the side collision occurs in order to secure space required to protect the passenger, thus enhancing the performance of protecting the passenger.

Furthermore, a side airbag system according to an exemplary embodiment of the present invention includes not only a side airbag apparatus but also the passenger-shift airbag apparatus so that the passenger can be more reliably protected from an impact when the side collision occurs.

Moreover, the present invention provides a method of controlling the side airbag system which predicts a side collision and previously deploys the passenger-shift airbag before the side collision happens, and moves up a point of time, at which the side airbag deploys, when the side collision is predicted to happen. Thus, the present invention can further enhance the performance of protecting the passenger when the side collision occurs.

For convenience in explanation and accurate definition in the appended claims, the terms “upper”, “lower”, “inner”, “outer”, “front”, and “rear” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A passenger-shift airbag apparatus, comprising:
an inflator installed at a predetermined position in a seat back of a vehicle; and
a passenger-shift airbag cushion fluid-connected to the inflator directly or by a gas supply tube, the passenger-shift airbag cushion being located in the seat back adjacent to a lateral side of the seatback, so that when the passenger-shift airbag cushion is inflated by gas supplied from the inflator, the passenger-shift airbag cushion shifts the passenger towards an inside of the vehicle.

2. The passenger-shift airbag apparatus as set forth in claim 1, further including:
a tether provided in the passenger-shift airbag cushion to connect the seatback and an inner surface of the passenger-shift airbag cushion.

3. The passenger-shift airbag apparatus as set forth in claim 2, wherein the tether has at least a gas guide hole to control a flow of the gas such that when the passenger-shift airbag cushion is inflated, the passenger-shift airbag cushion first pushes the outside shoulder and the abdomen of the passenger inwards.

4. A side airbag system, comprising:
the passenger-shift airbag apparatus according to claim 1;
a side airbag apparatus provided in the seatback at a predetermined position spaced apart from the passenger-shift airbag apparatus in a predetermined distance;
a vehicle-operation-condition sensing module having sensors sensing operational conditions of the vehicle that include whether a brake of the vehicle is normal, a speed, a yaw rate and a position of the vehicle;
a pre-crash sensor sensing another vehicle approaching a sidewall of the vehicle;
a side impact sensor sensing a side collision of the vehicle; and
a control unit controlling deployment of the passenger-shift airbag apparatus and the side airbag apparatus and points of time of the deployment of the passenger-shift airbag apparatus and the side airbag apparatus, depending on information collected from the vehicle-operation-condition sensing module, the pre-crash sensor and the side impact sensor.

5. A method of controlling the side airbag system according to claim 5, comprising the steps of:
receiving pre-crash sensing information from the vehicle-operation-condition sensing module and the pre-crash sensor;
determining whether the another vehicle predicted to cause the side collision is approaching the vehicle at a predetermined speed or more from a predetermined direction using the pre-crash sensing information;
determining whether there is a 100% probability that the another vehicle predicted to cause the side collision collides with the vehicle at a speed higher than a reference speed; and
deploying the passenger-shift airbag apparatus at a point of time earlier than a point of time of the collision when it is determined that the probability of the side collision is 100%.

6. The method as set forth in claim 5, further having the steps of:
between the determining of whether the another vehicle predicted to cause the side collision is approaching the vehicle and the determining whether the probability is 100%,
moving up a reference time point at which the side airbag apparatus deploys, when it is determined that the another vehicle predicted to cause the collision is approaching the vehicle at the predetermined speed or more from the predetermined direction;
after the deploying of the passenger-shift airbag apparatus,
determining whether the side collision has occurred using information transmitted from the side impact sensor; and
deploying the side airbag apparatus at a predetermined point of time when it is determined that the side collision has occurred.

7. The method as set forth in claim 5, further having the steps of:
in the determining of whether the side collision predicted vehicle approaches the vehicle, when it is determined that the another vehicle predicted to cause the side collision is not approaching the vehicle at the predetermined speed or more from the predetermined direction,
determining whether the side collision has occurred using information transmitted from the side impact sensor; and
when it is determined that the side collision has occurred,
deploying the side airbag apparatus at a predetermined point of time or deploying the passenger-shift airbag apparatus and the side airbag apparatus at a same time at a predetermined point of time.

8. The method as set forth in claim 5, further having the steps of:
in the determining of whether the probability is 100%, when it is determined that the probability is not 100%,
determining whether the side collision has occurred using information transmitted from the side impact sensor;
when it is determined that the side collision has occurred,
deploying the passenger-shift airbag apparatus at a predetermined point of time; and
when it is determined that the side collision has occurred,
deploying the side airbag apparatus at the predetermined point of time.

9. The method as set forth in claim 8, further having the steps of:
in the determining of whether the side collision has occurred, when it is determined that the side collision has not occurred,
resetting a reference time point at which the side airbag apparatus deploys to an origin.

10. The method as set forth in claim 6, further having the steps of:
in the determining of whether the side collision has occurred, when it is determined that the side collision has not occurred,
resetting the reference time point at which the side airbag apparatus deploys to an origin.
